(19) United States
(12) Patent Application Publication
(10) Pub. No.: US 2015/0012308 A1
(43) Pub. Date: Jan. 8, 2015

(54) AD HOC GROUPS OF MOBILE DEVICES TO PRESENT VISUAL AND/OR AUDIO EFFECTS IN VENUES

(71) Applicant: Harry Snyder, Sammamish, WA (US)

(72) Inventor: Harry Snyder, Sammamish, WA (US)

(21) Appl. No.: 14/312,373

(22) Filed: Jun. 23, 2014

Related U.S. Application Data
(60) Provisional application No. 61/843,269, filed on Jul. 5, 2013.

(51) Int. Cl. H04W 4/08; H04W 84/18; H04W 4/02; G06Q 10/02

(52) U.S. Cl. CPC H04W 4/08; G06Q 10/02; H04W 84/18; H04W 4/02
USPC 705/5

(57) ABSTRACT

Systems and methods supplement events to allow attendee participation using mobile devices. Individual attendees are generally associated with a location at the event venue, and the corresponding mobile devices of attendees execute instructions based on the location to provide visual and/or aural output according to one or more specified sequences during at least a portion of the event. The operation of mobile devices as ad hoc groups allows for the event to be supplemented with a light and/or sound show produced via the cumulative mobile devices in a venue. Mechanisms for implementing the above systems and methods include mobile applications for mobile devices and authoring and distribution mechanisms for authoring a media show across a venue and distributing control sequences across mobile devices.

### BACKGROUND

1. Technical Field

This description generally relates to events and venues at which events take place, such as performances in a concert hall, theater, auditorium, stadium or other facility, or sports events or games at stadiums, arenas, or other facilities.

2. Description of the Related Art

Performers and/or athletes perform or otherwise take part in events performed at various venues. Attendees (e.g., audience, fans, supporters) attend these performances at various venues. Typically, the attendees purchase or otherwise obtain tickets for entrance. These tickets are often associated with specific seats in the venue.

At some events the attendees participate, for example by cheering, singing, or standing up and sitting down in sequence in an act commonly referred to as “the wave” due to the visual semblance to a wave rotating through the crowd at the venue. Sometimes, the attendee participation is synchronized or coordinated with the performers (e.g., musicians, band). In some instances wristbands have been distributed at concerts, with integrated LEDs. These wristbands are wirelessly controlled so that a performer at a venue can cause the LEDs in the wristbands to activate for an event. These wristbands are disposable, so that they can be disposed of after the performance.

### BRIEF SUMMARY

A light, sound or light and sound show authoring system to configure light, sound, or light and sound shows by ad hoc groups of mobile devices may be summarized as including at least one non-transitory processor readable medium that stores seating layouts for each of a number of venues, the seating layouts specifying for each respective venue a respective position of each of a plurality of seats in the respective venue for at least one event scheduled for the respective venue; and at least one circuit communicatively coupled to the at least one non-transitory processor readable medium, and which provides a user interface including a plurality of tools to create at least one of a light show, a sound show or a light and sound show to be presented via an ad hoc group of mobile devices, the at least one circuit which further produces, based at least in part on a respective seating layout for a selected one of the venues, a plurality of sets of instructions executable by each of a plurality of mobile devices possessed by respective ones of a plurality of attendees of at least one event at the selected one of the venues, a respective set of instructions for each of a plurality of locations in the venue for at the at least one event, the set of instructions specifying a temporal sequence of instructions to actuate at least one transducer of the respective mobile devices to emit at least one of light, sound, or light and sound which in totality form at least part of the light show, the sound show or the light and sound show.

The at least one circuit may include at least one processor unit, and may further include at least one display communicatively coupled to the at least one processor unit to present at least a portion of the user interface. The at least one processor unit may generate a respective set of instructions for each seat in the venue, each seat constituting a respective separable addressable unit in the light show, the sound show or the light and sound show. The at least one processor unit may provide a grouping tool as part of the user interface, operation of which groups two or more seats as a single separable addressable unit in the light show, the sound show or the light and sound show, and the at least one processor unit may generate a respective set of instructions for each respective group of seats in the venue. The at least one processor unit may provide a grouping tool as part of the user interface, operation of which groups two or more seats as a single separable addressable unit in the light show, the sound show or the light and sound show, based at least in part on a respective ticket status of the seats indicative of whether a ticket for the seat has been sold, and the at least one processor unit may generate a respective set of instructions for each respective group of seats in the venue. The at least one processor unit may provide a grouping tool as part of the user interface, operation of which groups two or more seats as a single separable addressable unit in the light show, the sound show or the light and sound show, based at least in part on a respective attendee registration status of the seats indicative of whether an attendee logically associated with the respective seat has registered to participate in the light show, the sound show or the light and sound show, and the at least one processor unit may generate a respective set of instructions for each respective group of seats in the venue. The at least one processor unit may provide a grouping tool as part of the user interface, operation of which groups two or more seats as a single separable addressable unit in the light show, the sound show or the light and sound show, based at least in part on a respective attendee active participation status of the seats indicative of whether an attendee logically associated with a seat is actively participating in the light show, the sound show or the light and sound show, and the at least one processor unit may generate a respective set of instructions for each respective group of seats in the venue. The at least one processor unit may provide at least one mapping tool as part of the user interface, operation of which logically maps seats to pixels to form at least one graphic. 9. The at least one processor unit may provide at least one mapping tool as part of the user interface, operation of which logically maps seats to pixels to form at least one text message. The at least one processor unit may provide at least one mapping tool as part of the user interface, operation of which logically maps seats to pixels to form at least one advertisement. The at least one processor unit may provide at least one mapping tool as part of the user interface, operation of which logically maps seats to pixels to form at least one visual effect that moves over time from one location to another location in the venue (e.g., scrolls wave like). The at least one processor unit may provide at least one mapping tool as part of the user interface, operation of which logically maps seats to sounds to form at least one aural message. The at least one processor unit may provide at least one mapping tool as part of the user interface, operation of which logically maps seats to sounds to form at least one aural message that moves over time from one location to another location in the venue. At least one non-transitory processor readable medium may store at least one of an address or a mobile number for each of at least some of the mobile devices. The at least one processor unit may provide a respective set of instructions to each of at least some of the mobile devices in response to a respective request from the mobile device. The at least one processor unit may provide a respective set of instructions to each of at least some of the mobile devices as a complete set before a start of the event. The at least one processor unit may provide at least a portion of a respective set of instructions to each of at least some of the mobile devices before a start of the event. The at least one processor unit may provide at least a portion of a respective set of instructions to each of at least some of the mobile devices after a start of the event. The at least one processor unit may push a respective set of instructions to each of at least some of the mobile devices. The at least one processor unit may incorporate a trigger event definition in the sets of instructions for the respective the light show, the sound show or the light and sound show. The at least one processor unit may incorporate a trigger event definition in the form of at least one of a sound or a visual cue in the sets of instructions for the respective the light show, the sound show or the light and sound show, the at least one of the sound or the visual cue substantially concurrently detectable by the mobile devices at the event. The trigger event definition may also include or be based on time of day or command from a server. The at least one processor unit may provide at least one game mapping tool as part of the user interface, operation of which logically maps seats to a set of alternating ON and OFF light emitting conditions that simulate a random pattern of illumination. The operation of the at least one game mapping tool may logically map seats to reduce a total number of the mobile devices alternating between the ON and OFF light emitting conditions over time. The operation of the at least one game mapping tool may logically map seats to have a defined number of the mobile devices remain in the ON light emitting condition at an end time, which indicates a winner of a game. Messaging could be used to provide winners with an indication of winning at the end of the game: for example, a user could receive a message informing the user that he is the winner of the game. The seat layout may include floor seating for at least one event for at least one of the at least one venues. A respective one of the seat layouts for a first event at a first one of the venues may be different from a respective seat layout for a second event at the first one of the venues.

A light, sound or light and sound show authoring method for configuring light, sound, or light and sound shows by ad hoc groups of mobile devices may be summarized as including providing seating layouts for each of a number of venues, the seating layouts specifying for each respective venue a respective position of each of a plurality of seats in the respective venue for at least one event scheduled for the respective venue; providing a user interface including a plurality of tools to create at least one of a light show, a sound show or a light and sound show to be presented via an ad hoc group of mobile devices; producing, based at least in part on a respective seating layout for a selected one of the venues, a plurality of sets of instructions executable by each of a plurality of mobile devices possessed by respective ones of a plurality of attendees of at least one event at the selected one of the venues, a respective set of instructions for each of a plurality of locations in the venue for at the at least one event, the set of instructions specifying a temporal sequence of instructions to actuate at least one transducer of the respective mobile devices to emit at least one of light, sound, or light and sound which in totality form at least part of the light show, the sound show or the light and sound show.

The light, sound or light and sound show authoring method may further include producing a respective set of instructions for each seat in the venue, each seat constituting a respective separable addressable unit in the light show, the sound show or the light and sound show.

The light, sound or light and sound show authoring method may further include grouping two or more seats as a single separable addressable unit in the light show, the sound show or the light and sound show, and generating a respective set of instructions for each respective group of seats in the venue.

The light, sound or light and sound show authoring method may further include grouping two or more seats as a single separable addressable unit in the light show, the sound show or the light and sound show, based at least in part on a respective ticket status of the seats indicative of whether a ticket for the seat has been sold, and generating a respective set of instructions for each respective group of seats in the venue.

The light, sound or light and sound show authoring method may further include grouping two or more seats as a single separable addressable unit in the light show, the sound show or the light and sound show, based at least in part on a respective attendee registration status of the seats indicative of whether an attendee logically associated with the respective seat has registered to participate in the light show, the sound show or the light and sound show, and generating a respective set of instructions for each respective group of seats in the venue.

The light, sound or light and sound show authoring method may further include grouping two or more seats as a single separable addressable unit in the light show, the sound show or the light and sound show, based at least in part on a respective attendee active participation status of the seats indicative of whether an attendee logically associated with a seat is actively participating in the light show, the sound show or the light and sound show, and generating a respective set of instructions for each respective group of seats in the venue.

The light, sound or light and sound show authoring method may further include logically mapping seats to pixels to form at least one graphic.

The light, sound or light and sound show authoring method may further include logically mapping seats to pixels to form at least one text message.

The light, sound or light and sound show authoring method may further include logically mapping seats to pixels to form at least one advertisement.

The light, sound or light and sound show authoring method may further include logically mapping seats to pixels to form at least one visual effect that moves over time from one location to another location in the venue (e.g., scrolls wave like).

The light, sound or light and sound show authoring method may further include logically mapping seats to sounds to form at least one aural message.

The light, sound or light and sound show authoring method may further include logically mapping seats to sounds to form at least one aural message that moves over time from one location to another location in the venue.

The light, sound or light and sound show authoring method may further include storing at least one of an address or a mobile number for each of at least some of the mobile devices.

The light, sound or light and sound show authoring method may further include providing a respective set of instructions to each of at least some of the mobile devices in response to a respective request from the mobile device.

The light, sound or light and sound show authoring method may further include providing a respective set of instructions to each of at least some of the mobile devices as a complete set before a start of the event. The light, sound or light and sound show authoring method may further include providing at least a portion of a respective set of instructions to each of at least some of the mobile devices before a start of the event.

The light, sound or light and sound show authoring method may further include providing at least a portion of a respective set of instructions to each of at least some of the mobile devices after a start of the event.

The light, sound or light and sound show authoring method may further include pushing a respective set of instructions to each of at least some of the mobile devices.

The light, sound or light and sound show authoring method may further include providing a trigger event definition in the sets of instructions for the respective the light show, the sound show or the light and sound show.

The light, sound or light and sound show authoring method may further include providing a trigger event definition in the form of at least one of a sound or a visual cue in the sets of instructions for the respective the light show, the sound show or the light and sound show, the at least one of the sound or the visual cue substantially concurrently detectable by the mobile devices at the event. The trigger event could also be a command from a server to the mobile device. The command could be a time indication indicating when to start the show, for example at a future time or immediately.

The light, sound or light and sound show authoring method may further include providing at least one game mapping tool, and logically mapping seats to a set of alternating ON and OFF light emitting conditions that simulate a random pattern of illumination. The operation of the at least one game mapping tool may logically map seats to reduce a total number of the mobile devices alternating between the ON and OFF light emitting conditions over time. The operation of the at least one game mapping tool may logically map seats to have a defined number of the mobile devices remain in the ON light emitting condition at an end time, which indicates a winner of a game. The seat layout may include floor seating for at least one event for at least one of the at least one venues. A respective one of the seat layouts for a first event at a first one of the venues may be different from a respective seat layout for a second event at the first one of the venues.

An assignment system to configure light, sound, or light and sound shows by ad hoc groups of mobile devices may be summarized as including at least one non-transitory processor readable medium that stores relationships between seating layouts for each of a number of venues and sets of instructions executable by mobile devices possessed by a plurality of attendees of at least one event at the selected one of the venues, the seating layouts specifying each respective venue a respective position of each of a plurality of seats in the respective venue for at least one event scheduled for the respective venue, and the set of instructions specifying a temporal sequence of instructions to actuate at least one transducer of the respective mobile devices to emit at least one of light, sound, or light and sound which in totality form at least part of the light show, the sound show or the light and sound show; and at least one circuit communicatively coupled to the at least one non-transitory processor readable medium, and which provides at least one of a set of instructions or a link to a set of instructions to each of a plurality of mobile devices based at least in part on a seat logically associated with the respective mobile device for an identified venue and an identified event scheduled at the identified venue.

The at least one circuit may include at least one processor unit, and may be communicatively coupled to a communications network to receive requests from the attendees and to provide the set of instructions to at least one of a computer system or a respective mobile device in response to received requests. The at least one circuit may include at least one processor unit, and may be communicatively coupled to provide the set of instructions to at least one of a computer system or a respective mobile device in response to ticket purchase. The at least one circuit may include at least one processor unit, and may be communicatively coupled to provide the set of instructions to at least one of a computer system or a respective mobile device as part of a ticket purchase. The at least one circuit may include at least one processor unit, and may be communicatively coupled to provide the set of instructions to at least one of a computer system or a respective mobile device in response to a registration with a service by at least one of a respective one of the attendees or a respective one of the mobile devices. The at least one circuit may include at least one processor unit, and may be communicatively coupled to receive seat specification information entered by an attendee and indicative of a seat in a venue at an event and to provide the set of instructions to at least one of a computer system or a respective mobile device in response to the received seat specification information. The at least one circuit may include at least one processor unit, and may be communicatively coupled to receive seat specification information as part of a ticket acquisition process which is indicative of a seat in a venue at an event and to provide the set of instructions to at least one of a computer system or a respective mobile device in response to the received seat specification information. The at least one circuit may include at least one processor unit, and may be communicatively coupled to receive location specification information include geolocation coordinates derived by a geolocation system.

An assignment method to configure light, sound, or light and sound shows by ad hoc groups of mobile devices may be summarized as including storing relationships between seating layouts for each of a number of venues and sets of instructions executable by mobile devices possessed by a plurality of attendees of at least one event at the selected one of the venues, the seating layouts specifying each respective venue a respective position of each of a plurality of seats in the respective venue for at least one event scheduled for the respective venue, and the set of instructions specifying a temporal sequence of instructions to actuate at least one transducer of the respective mobile devices to emit at least one of light, sound, or light and sound which in totality form at least part of the light show, the sound show or the light and sound show; and providing at least one of a set of instructions or a link to a set of instructions to each of a plurality of mobile devices based at least in part on a seat logically associated with the respective mobile device for an identified venue and an identified event scheduled at the identified venue.

The assignment method may further include receiving requests from the attendees over a communications network and providing the set of instructions to at least one of a computer system or a respective mobile device in response to received requests.

The assignment method may further include providing the set of instructions to at least one of a computer system or a respective mobile device over a communications network in response to ticket purchase.

The assignment method may further include providing the set of instructions to at least one of a computer system or a respective mobile device over a communications network as part of a ticket purchase.

The assignment method may further include providing the set of instructions to at least one of a computer system or a respective mobile device in response to a registration with a service by at least one of a respective one of the attendees or a respective one of the mobile devices.

The assignment method may further include receiving seat specification information entered by an attendee and indicative of a seat in a venue at an event and providing the set of instructions to at least one of a computer system or a respective mobile device in response to the received seat specification information.

The assignment method may further include receiving seat specification information as part of a ticket acquisition process which is indicative of a seat in a venue at an event and providing the set of instructions to at least one of a computer system or a respective mobile device in response to the received seat specification information.

The assignment method may further include receiving location specification information including geolocation coordinates derived by a geolocation system.

A system to control ad hoc groups of mobile devices may be summarized as including at least one non-transitory processor readable medium that stores at least one of processor-executable instructions or data; and at least one circuit communicatively coupled to the at least one non-transitory processor readable medium, and which provides a plurality of sets of instructions executable by each of a plurality of mobile devices possessed by respective ones of a plurality of attendees of at least one event at a venue, the sets of instructions which cause at least one transducer of the respective mobile devices to alternate between emitting and not emitting light in an at least simulated random pattern, and which cause the transducer of all except a defined number of the respective mobile devices to stop alternating and no longer emit light after a period, to indicate at least one winner of a game.

The at least one circuit may provide the sets of instructions only to mobile devices that have registered to participate in the game. The at least one circuit may provide the sets of instructions which reduce a total number of the mobile devices alternating between emitting and not emitting light over time. The at least one circuit may provide the sets of instructions which linearly reduces a total number of the mobile devices alternating between emitting and not emitting light over time. The at least one circuit may provide the sets of instructions which nonlinearly reduces a total number of the mobile devices alternating between emitting and not emitting light over time. The at least one non-transitory processor readable medium may store a seating layout for at least the venue, the seating layouts specifying a respective position of each of a plurality of seats in the venue for at least one event scheduled for the venue; and the at least one circuit may provide the sets of instructions only to mobile devices based on a position of a respective seat logically associated with the mobile device. The at least one non-transitory processor readable medium may store a seating layout for at least the venue, the seating layouts specifying a respective position of each of a plurality of seats in the venue for at least one event scheduled for the venue; and the at least one circuit may verify a winner of the game based at least in part on a position of a respective seat logically associated with the mobile device. The at least one circuit may incorporate a trigger event definition in the form of at least one of a sound or a visual cue in the sets of instructions, the at least one of the sound or the visual cue substantially concurrently detectable by the mobile devices at the event. At least one non-transitory processor readable medium may store at least one of an address or a mobile number for each of at least some of the mobile devices.

A method to control ad hoc groups of mobile devices may be summarized as including providing a plurality of sets of instructions executable by each of a plurality of mobile devices possessed by respective ones of a plurality of attendees of at least one event at a venue, wherein the sets of instructions cause at least one transducer of the respective mobile devices to alternate between emitting and not emitting light in an at least simulated random pattern, and causes the transducer of all except a defined number of the respective mobile devices to stop alternating and no longer emit light after a period, to indicate at least one winner of a game.

The sets of instructions may be provided to mobile devices that have registered to participate in the game. The sets of instructions may execute to reduce a total number of the mobile devices alternating between emitting and not emitting light over time. The sets of instructions may execute to linearly reduce a total number of the mobile devices alternating between emitting and not emitting light over time. The sets of instructions may execute to nonlinearly reduce a total number of the mobile devices alternating between emitting and not emitting light over time.

The method may further include storing a seating layout for at least the venue, the seating layouts specifying a respective position of each of a plurality of seats in the venue for at least one event scheduled for the venue; and providing the sets of instructions to mobile devices based on a position of a respective seat logically associated with the mobile device.

The method may further include storing a seating layout for at least the venue, the seating layouts specifying a respective position of each of a plurality of seats in the venue for at least one event scheduled for the venue; and verifying a winner of the game based at least in part on a position of a respective seat logically associated with the mobile device.

The method may further include incorporating a trigger event definition in the form of at least one of a sound or a visual cue in the sets of instructions, the at least one of the sound or the visual cue substantially concurrently detectable by the mobile devices at the event.

The method may further include storing at least one of an address or a mobile number for each of at least some of the mobile devices.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements and angles are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic diagram of a show authoring and distribution system according to one illustrated embodiment, which may be used to design light or sound components or shows for a media show such as a concert at a venue and distributing information regarding the show across user devices.

FIG. 2 is a functional block diagram of a computer system suitable for use in the authoring and distribution system of FIG. 1, according to one illustrated embodiment, communicatively coupled with a number of mobile devices such as smartphones.

FIG. 3A is a schematic diagram of an exemplary venue plan which may be used by a show authoring and distribution system to author a media show incorporating mobile devices outputting sound or light as desired.

FIG. 3B is a detailed schematic diagram of an exemplary venue plan including seating which may be used in a show authoring and distribution system to author a media show incorporating mobile devices outputting sound or light as desired.

FIG. 4 is a schematic diagram of a user interface presentable by the computer system of the authoring and distribution system of FIG. 1, according to one illustrated embodiment.

FIG. 5 is a schematic diagram of a user interface presentable by a mobile device to present light or sound in response to information generated by the authoring and distribution system of FIG. 1, according to one illustrated embodiment.

FIG. 6A is a flowchart showing a high level method of operating an authoring and a distribution system or a combined authoring and distribution system, according to one illustrated embodiment.

FIG. 6B is a low level flowchart showing method of operating an authoring and a distribution system or a combined authoring and distribution system, according to one illustrated embodiment, useful in performing the method of FIG. 6A.

FIG. 6C is a low level flowchart showing method of operating an authoring and a distribution system or a combined authoring and distribution system, according to one illustrated embodiment, useful in performing the method of FIG. 6A.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with mobile devices, computers, servers, computer networks, data structures, databases, and networks such as the Internet or cellular networks, have not been described in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the claimed invention.

Events such as concerts, sports or games provide entertainment to attendees. It is desirable to enhance events for attendees, to make events more interesting or exciting to the attendees. Attendees may want to demonstrably participate in the event or otherwise participate in an activity in breaks between portions of an event. For instance, attendees may want to participate in an activity prior to a start of an event such as a show, during intermission, half-time, between periods or innings (e.g., seventh inning stretch). Such may heighten the entertainment value of the event, and perhaps allow attendees to engage with other attendees, for example through conveying a common sense of enthusiasm. To this end, this application describes systems and methods to allow attendee participation in an event or during an event, through broad attendee participation via mobile devices.

Specifically, aspects leverage an attendee's mobile device to allow the attendee to participate in an event. Taking a concert as an example, multiple attendees will have multiple mobile devices (e.g., smartphones). Mobile devices across a swath of attendees may be actuated as ad hoc groups or sets to provide an output pattern at the event. Thus, the attendees may participate in an event by displaying their mobile devices, which are controlled to produce a light, sound or light and sound presentation or show via the respective displays and/or speakers of the mobile devices. Taken together, the mobile devices are operated as ad hoc groups or sets to, for example provide a light show, allowing attendees to participate in the event in a collaborative or collective form. Of course, light from the mobile device is just one possible output medium, and the mobile devices may additionally or alternatively operate in ad hoc groups or sets to cumulatively produce a sound show. Further, the mobile devices may additionally or alternatively operate in ad hoc groups or sets to cumulatively produce a light and sound show.

An attendee is often allocated a defined location in a venue, such as a specified seat, for an event. The location may be specified as an absolute or as a relative location (i.e., location relative to some other location or landmark). Thus, for many events, the location of individual attendees at an event may be relatively deterministic. Consequently, each attendee may be logically associated with a relative location in the venue, such as a seat or section. A system may compile the information correlating attendees or attendee mobile devices with locations within a venue. Once the location for each attendee is specified, mobile devices of attendees at different locations can be controlled, for example relative to each other, in conjunction or in tandem as ad hoc groups or sets. For example, the mobile devices may be controlled to produce a defined or specified pattern of output based at least in part on the locations of mobile devices. Thus, one can design a visual output pattern spanning the venue or portion thereof, operating each mobile device or groups of mobile devices as respective pixels to create a visual effect (e.g., still or moving image, text). One can additionally or alternatively design an aural output pattern spanning the venue or portion thereof, operating each mobile device or groups of mobile devices to create an aural effect (e.g., still or moving sound effect). This approach may advantageously control a large number of mobile devices as an ad hoc group or set, to essentially create an enormous display screen, each of the mobile devices or a subset of mobile devices (e.g., 4×4), being operated as an effective pixel in a visual or aural presentation.

To implement the output pattern across the venue at the event, end-user mobile devices of participating end user attendees at an event are provided with sequences for actuation which are associated with the respective end-user location in the venue hosting the event. For example, sets of instructions specifying an activation sequence may be provided to attendee mobile devices based on seat locations. This allows for generation and distribution of sequences for driving mobile devices at an event to cause the mobile devices to produce a visual and/or aural output in combination with each other. Such may optionally be integrated into a performance being presented at the venue, such as integrated into a concert. Such may advantageously supplement the event with additional media or presentation such as light show presented or performed using visual or aural output of a large number of mobile devices. Attendee participation in the event may heighten the experience for the attendee. In one non-limiting example, an application running on a mobile device may receive a screen control sequence which causes the mobile device screen to output light in conjunction or in combination (e.g., spatially and/or temporally) with other mobile devices at a venue during an event.

Turning to an authoring system for such as described above, an authoring system can, based on the layout of a venue, generate sets of instructions which cause mobile devices to be actuated at certain times based on an anticipated or a known location of the respective mobile device in a venue. The mobile devices may execute an application, for instance downloaded prior to the event or prior to entering the venue. The application may capture location information which specifies the actual or the likely location of the attendee or mobile device in or at the venue, providing the information to either an authoring system and/or distribution or assignment system. The location information may, for example, take the form of a seat location (e.g., floor, aisle, row, seat number) at the venue for the particular event. Based upon receiving respective venue locations associated with various attendees, an assignment system may provide activation sequences to the respective mobile devices, such as, for example, by assigning generated sets of instructions to respective mobile devices. These generated sets of instructions may be executed by the respective mobile devices during the event to cause the mobile devices to produce output (e.g., visual and/or aural). The combined output of the mobile devices may produce a show, for instance a light show or other media show across all or a portion of the venue. For instance, sequential operation of the mobile devices may produce a light wave or sound wave, which appears to roll across the venue, or which oscillates from one side of a venue to the other. The instructions may be designed to achieve other visual and/or aural effects or patterns.

As a whole, the sets of instructions provided to the mobile devices specify a sequence and time of output, and optionally a type of output (e.g., visual, aural) for each participating mobile device at an event. These sets of instructions are associated with venue locations at which the mobile device actually is, or is at least expected to be, located. The distribution or assignment system may provide the instructions to the mobile devices in response to the mobile device being associated with a respective venue location. The venue location associated with an attendee or mobile device may be a specific seat, or may be less granular, for instance a location of a group or set of seats such as a section of the venue. In this way, mobile devices are provided with the correct sequence for generating a defined output for the respective venue locations of the attendee or mobile device at the defined times, such that the mobile devices operate as an ad hoc group or set to cumulatively present a visual and/or aural presentation, effect or show.

As briefly noted, a mobile device may execute an application which allows for participating in an event at a venue as detailed above. The application determines a location of the user or mobile device within the venue. The application could derive location information in a variety of ways. For example, the location information may be identified or collected when tickets are purchased, the tickets typically specifying a specific location in the venue (i.e., venue location) such as assigned seats. Alternatively or additionally, the respective venue location information associated with various attendees or mobile devices may be identified or derived via user input, for instance by the user entering venue identification (e.g., name), event identification (e.g., name, date, time), seat or position information (e.g., section, row and/or seat information) via a keypad or virtual keyboard of the mobile device. Alternatively or additionally, the mobile device may identify or collect the respective location information associated with various attendees or mobile device via a global positioning system receiver or via triangulation with cellular or wireless antennas or base stations if the mobile device is sufficiently equipped. Position can also be determined by relative position to other devices using Bluetooth or other communication mechanism or protocol. Alternatively or additionally, the mobile device may identify or collect the respective location information associated with various attendees or mobile device via imaging of a machine-readable symbol associated with, for instance respective seats or rows, aisles or sections. Alternatively or additionally, the mobile device may identify or collect the respective location information associated with various attendees or mobile device via imaging of a surrounding environment, from which at least approximate location can be discerned by comparison to reference images of the venue. Such may be performed, for example by the distribution or assignment system 140.

The mobile device or, more specifically, the relevant application executing thereon may receive generated sets of instructions specifying commands for providing output from the mobile device for an event. At least some of the mobile devices may receive the sets of instructions before a start of the event, thereby alleviating burdens on possibly limited communications resources at the venue. Additionally or alternatively, some of the mobile devices may receive the respective sets of instructions during at the venue during the event, or even in real time. For example, the respective generated sets of instructions may be downloaded to a mobile device when the mobile device is used to purchase tickets to the event and the seating is determined. Instructions may also be downloaded to the mobile device when the event is known and before a seat or the seating is allocated by downloading sets of instructions for the seating throughout the venue for the event. This allows automatic correlation of the mobile device with a respective venue location and the respective output sequence logically associated with that respective venue location of the attendee or mobile device. Additionally or alternatively, the mobile device(s) may wirelessly receive instructions in real time during the event. Instructions may be sent to an application executing on the mobile device via various forms of wireless communications, for example WI-FI, multi-cast transmissions, uni-cast, or other transmission mechanism. In aspects, mobile devices could be signaled to operate according to the received sets of instructions via a signal such as a broadcast of a synchronization signal or a trigger signal. Synchronization or a trigger signal may allow a large number of mobile devices, or example smartphones employing a variety of communications providers or carrier networks to operate synchronously to cumulatively produce visual or aural effects. For example, a mobile device executing an application might receive a wireless synchronization signal or triggering signal. Alternatively, the mobile device may synchronize or trigger from a clock, for instance a real time clock executing on the mobile device or a time signal sent by the communications provider or carrier network. As a further alternative, the mobile devices may detect signals which are part of a performance or part of the event. For instance, a microphone in the mobile device may detect sounds and/or a camera in the mobile device may detect light (e.g., strobe, flashes). A processor of the mobile device may determine whether the detected condition (e.g., sound, light, combination of sound or light) correspond to a defined cue or trigger signal. Such may synchronize a plurality of mobile devices or to trigger some or all of the devices to produce defined output to cumulatively create a visual and/or aural presentation. Thus, a chord played by a performer and detectable by mobile devices may serve as a synchronization or trigger signal. Additionally or alternatively, a flash associated with a controlled explosion, turning ON or OFF of lights may serve as a synchronization or trigger signal. Instructions may specify offsets from a start, synchronization signal or triggering signal for executing various commands to produce the desired visual or aural output.

Venues typically are limited in use to certain days and times. Thus, communications carriers or providers tend to devote limited resources to venues. Yet during these times of use, a venue may hold 10,000, 30,000, 80,000 or more people. As would be appreciated by one of skill in the art, wirelessly controlling mobile devices in real-time or dynamically during an event has the potential of being bandwidth intensive or raising issues of signal interference. To reduce bandwidth demands at a venue during an event it may be desirable to have mobile devices obtain the respective sets of instructions specifying respective transducer activation sequences before a start of an event, and even before an attendee arrives at the venue.

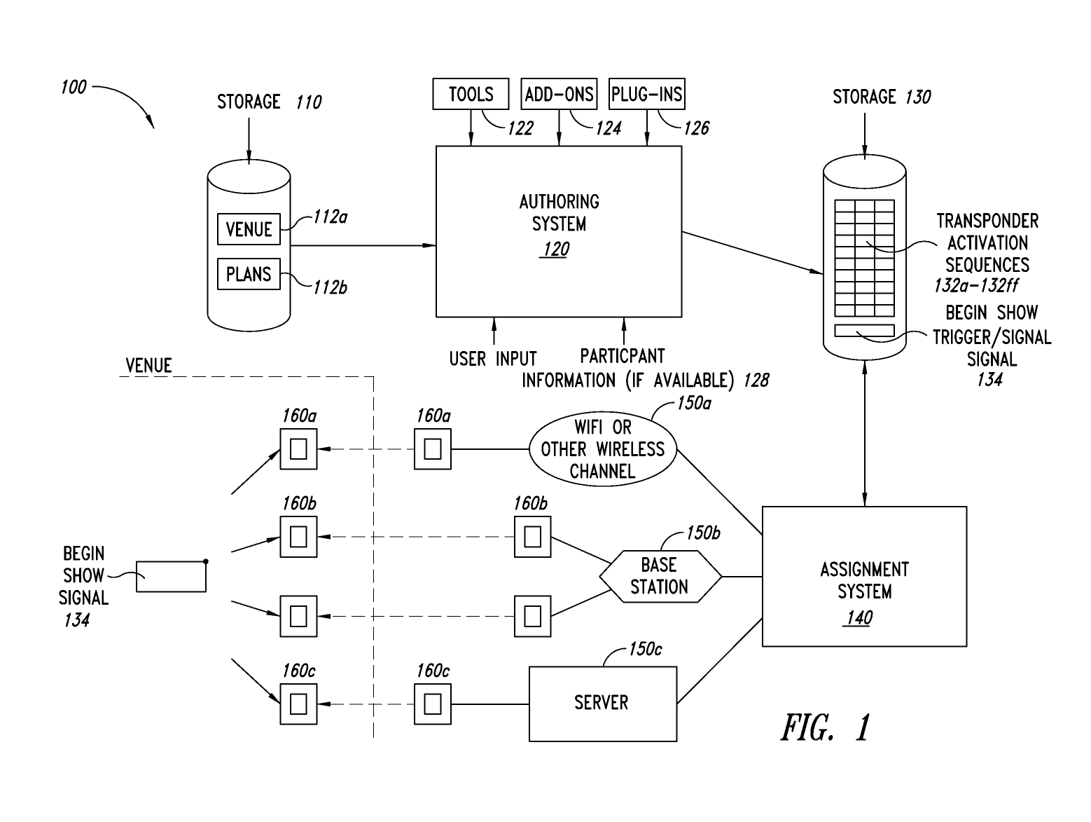

FIG. 1 shows a show authoring and distribution system 100, according to one illustrated embodiment. The show authoring and distribution system is useful in designing light or sound components or light, sound or light and sound shows for cumulative presentation via plurality of mobile devices such as smartphones during an event at a venue. The show authoring and distribution system is useful in distributing information, for example sets of executable instructions, to the various mobile devices for performing the shows. While FIG. 1 illustrates an authoring system 120 authoring light show(s) for an event and a separate and distinct distribution or assignment system 140 for providing the resultant sets of instructions to respective mobile devices, in some implementations a combined system may be employed to both author shows and distribute the resulting instructions to the mobile devices.

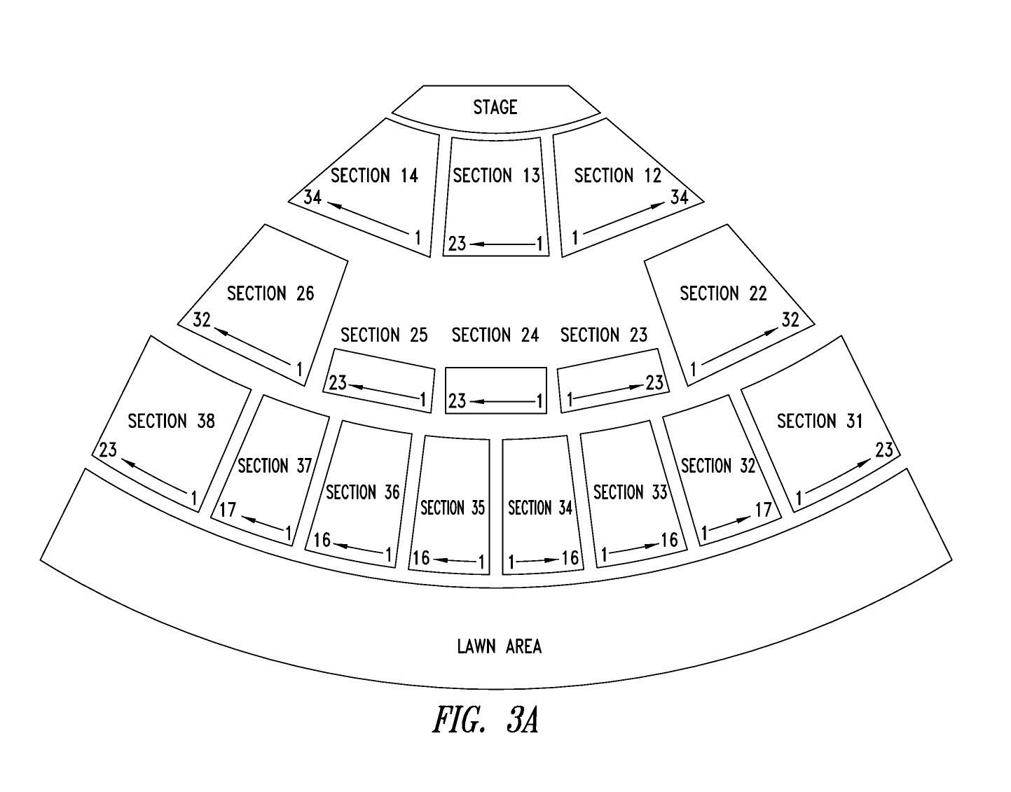

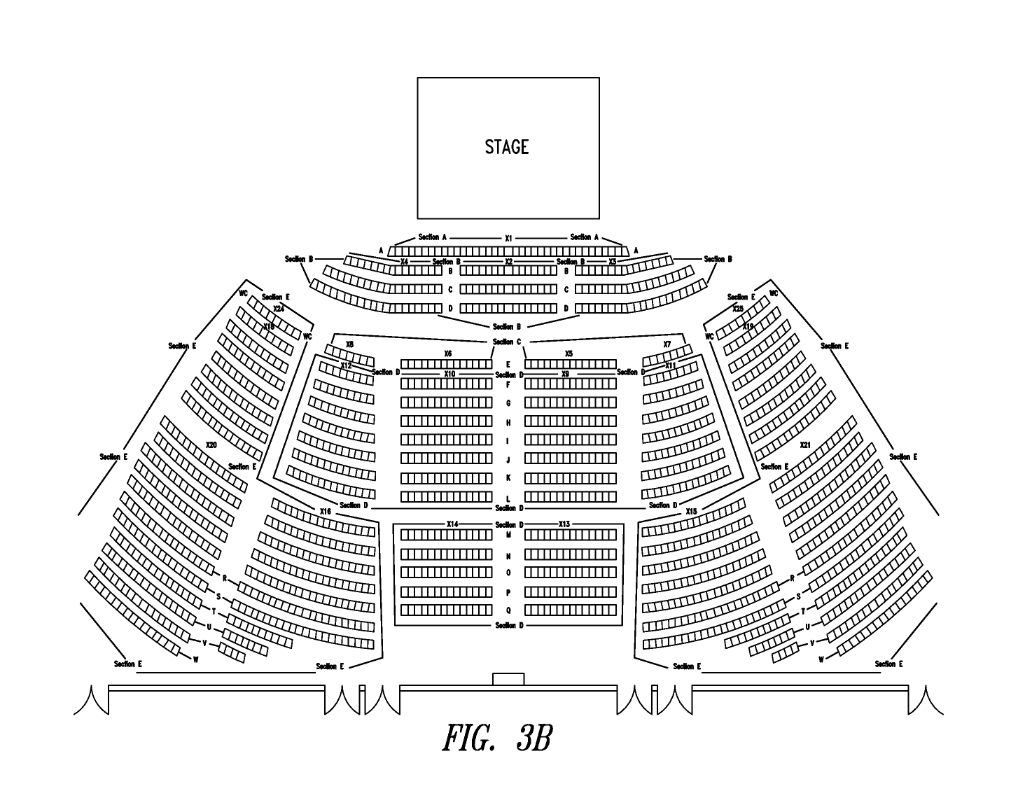

The authoring system 120 is communicatively coupled to access non-transitory storage 110, and various venue plans (e.g., venue plans 112a and 112b) stored therein. The storage 110, which may be any type of non-transitory computer- or processor-readable storage or memory. The venue plans 112a, 112b (collectively 112) may, for example, specify location information for a particular venue, for example layout or seating information. The venue plans 112 may be generic to a venue for all events held at the venue. Alternatively, venue plans may be specific to events held at a venue. For instance, a first venue plan may specify a layout used for one type of event held at a venue, while a second venue plan may specify a second, different layout, for a second type of event held at the venue. Some example venue plans are illustrated in FIGS. 3A and 3B. As shown in FIGS. 3A and 3B, venue plans 112 may include attendee location information for the venue and/or specific event performed at the venue.

The authoring system 120 is also communicatively coupled to non-transitory storage 130, to which the authoring system 120 outputs generated sets of instructions, also denominated herein and in the claims as transducer activation sequences 132a-132ff (collectively 132). The storage media 110 and 130 may be part of the same memory system or device, or may take the form of separate and distinct memory structures or non-transitory storage devices.

The distribution or assignment system 140 is communicatively coupled to the access storage 130, and can access the generated transducer activation sequences 132 stored therein. The distribution or assignment system 140 and the authoring system 120 may be separate and distinct systems, or may be integrated modules or programs.

The distribution or assignment system 140 is also communicatively coupleable with a plurality of mobile devices 160a-160c (only three shown, collectively 160). The distribution or assignment system 140 is communicatively coupleable with the mobile devices 160 via one or more communications networks 150a-150c (three shown, collectively 150). The communications networks 150 may take any of a large variety of forms. The communications networks 150 will typically take the form of cellular wireless networks, for example voice or data networks operating under GSM, LTE, G4 communications protocols, or shorter range networks such as WI-FI® networks, or may even employ BLUETOOTH® communications protocols.

The distribution or assignment system 140 logically associates mobile devices 160a-160c with respective attendees who attend an event at a venue and/or with locations in the venue for the event.

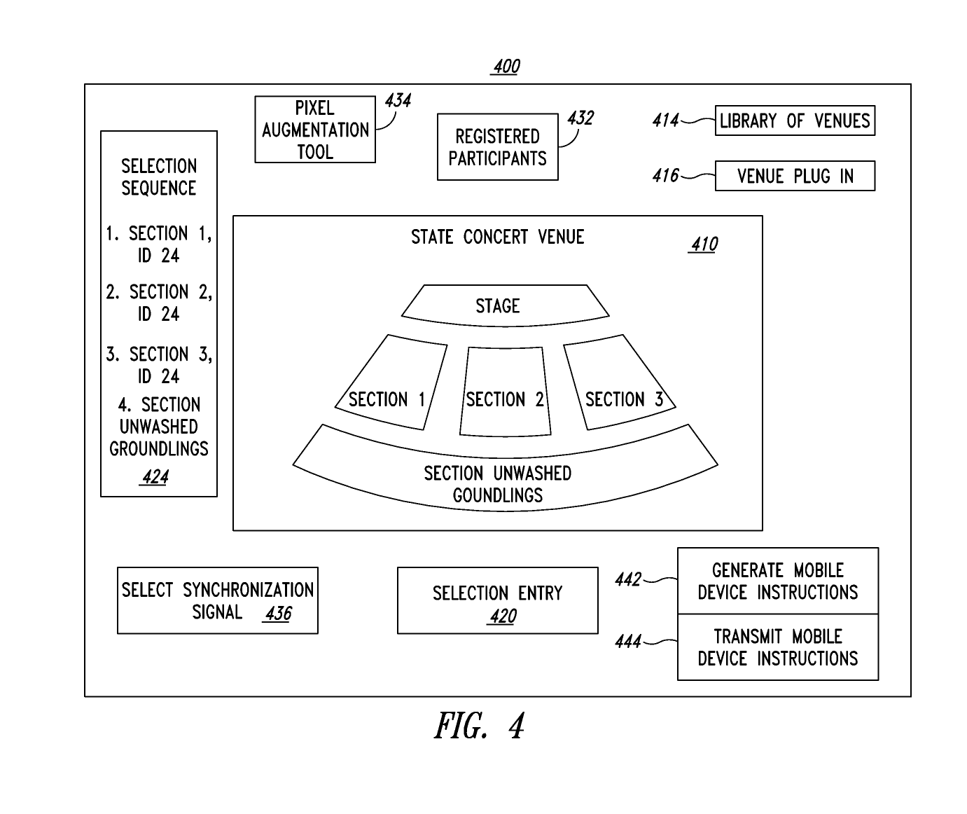

Turning to the operation of system 100, the authoring system 120 executes instructions that cause at least one component of the authoring system 120 to provide or present a user interface, for example the user interface 400 illustrated in FIG. 4. The user selects the desired venue, and may select the desired event via the user interface. Based on the user input, the authoring system 120 accesses a venue and/or event plan from storage 110 for the selected venue and/or event, for example venue plan 112b. The authoring system 120 displays a graphic of a layout of the venue, for the event, which may include a seating break-down such as illustrated in FIG. 3B.

The user interface of the authoring system 120 may include tools 122, add-ons 124 and plug-ins 126. The authoring system 120 allows an end user to design individual visual or aural or visual and aural effects, and/or design a show comprising sets of visual or aural or visual and aural effects. The visual or aural or visual and aural effects are cumulatively presentable by a plurality of mobile devices (e.g., smartphones) operating as ad hoc collections, groups or sets, according to sets of instructions. As explained in more detail herein, individual mobile devices or groups or sets of mobile devices may be mapped as pixels to a visual effect or as an analog of a pixel or independently addressable unit to aural effects.

The authoring system 120 may include a number of pre-designed visual or aural effects for the end user to choose from. For example, wave effect mobile devices are operated sequentially around or through a venue to produce light or sound that appears to sequentially circulate or oscillate about or through the venue. For instance, light or sound may appear to circulate around a circular or oval pattern through the venue. Also for instance, light or sound may appear to oscillate between two points in the venue, for example from front-to-back then from back-to-front in floor seating of a venue. As a further example, multiple waves of light or sound may pass through the venue, for example one trailing the other, or moving in opposite directions to overlap or intersect from time to time. Pre-designed effects may include mappings of colors, or example colors associated with performers. Colors may for instance be colors associated with a sport team performing at the venue. Pre-designed effects may include graphical images and/or messages (e.g., text, numbers). For instance, a tour logo for a band or a team logo for a sports team, or a sponsor logo for a sponsor may be pre-designed and stored for ready access by a user. Other effects may likewise be stored, for instance effects produced in response to certain occurrences during an event, such as scoring a touchdown, hitting a home run, starting an encore, or performing selected songs.

The authoring system 120 may include a number of user interface tools for creating visual or aural effects. For instance, the authoring system 120 may include user interface tools for drawings images, graphics, or messages. The authoring system 120 may include user interface tools for importing existing or previously created images, graphics, or messages. The authoring system 120 may include a user interface tool or element which allows an end user to, for example, select a location in the venue for a visual and/or aural effect and to specify the visual and/or aural effect for the selected location.

The authoring system 120 may include instructions that convert images, graphics, or messages into pixels. The authoring system 120 may include instructions that map pixels to individual locations in the venue for the event, for example mapping each pixel to an individual seat or to a group or set of seats (e.g., 2×2 seats, 4×4 seats, 8×8 seats).

The authoring system 120 may receive participant information 128, if and when such information becomes available. Participant information may, for example, identify specific participants or mobile devices of attendees (e.g., ticketholders) who have opted to participate in the light, audio or light and audio show to be presented at the event via ad hoc groups or sets of mobile devices. Participation information may represent expected participation, for instance attendees who have indicated they will or want to participate. Alternatively or additionally, participation information may represent actual participation, collected in real- or almost real-time form information provided via the applications executing on the various mobile devices.

The authoring system 120 may use the participant information in the mapping the pixels to respective locations. For example, the authoring system 120 may group multiple seats as an effective pixel based on a relative density of participation in a general location in the venue. For instance, participation may be higher closer to the floor or stage than in more remote areas. In response, the authoring system 120 may employ a 1:1 mapping between pixels and seats on the floor of the venue, while employing a 1:8 mapping between pixels and seats in an upper deck level of the same venue for the same event. Also for instance, the authoring system 120 may move or position various effects based in indicated participation rate at various locations in the venue.

Based on the user input, the venue layout, and optionally on participation information, the authoring system 120 generates sets of instructions for each of a plurality of locations in the venue. The instructions specify when and how to actuate a transducer of a mobile device located at the respective location to produce the defined visual or aural effect or show. The locations may be individual seats or may be a group or set of seats. The authoring system 120 stores the sets of instructions in non-transitory storage 130, as transducer activation sequences 132a-132ff.

The authoring system 120 may also provide a tool that allows the end user author to select a signal for synchronizing execution of the sets of instructions or to select a signal for triggering execution of the sets of instructions or execution of instructions corresponding to individual visual or aural effects. As noted above, such synchronization or trigger signals may be wireless signals, times, or detected activities such as a sound played over a public address system or by a performer and/or a visual cue such as a flash of light or dimming of house lights. The authoring system 120 may store the synchronization or trigger signal in storage 130.

Thus, the authoring system 120 generates sets of instructions specifying transducer activation sequences for execution by mobile devices. Each set of instructions is correlated with a respective venue location, such that locations across a venue are logically associated with respective sets of instructions. As previously noted, execution of these sets of instructions by the mobile devices cause activation of one or more transducers in a specified activation sequence to produce visual and/or aural output over time. Such may specify a simple ON/OFF pattern, or more complex patterns including color, frequency or tone, etc.

The distribution or assignment system 140 is communicatively coupled to the access storage 130. In particular, the distribution or assignment system 140 accesses the stored transducer activation sequences 132 together with the associated locations in the venue to which the respective stored transducer activation sequences 132 correspond. The distribution or assignment system 140 is communicatively coupleable with mobile devices 160 via communication networks 150 at some time either prior to or during the event.

Attendees may register their respective mobile devices with the distribution or assignment system 140, for example via a downloaded application, commonly referred to as “apps” or via a Website. For example, an attendee may actuate their mobile device to provide their respective venue location information to the distribution or assignment system 140, such as a seat or section at the event.

Based upon the location information, the distribution or assignment system 140 accesses storage 130 and determines which of transducer activation sequences 132a-132ff are logically associated with the location in the venue for the particular event. The distribution or assignment system 140 provides the respective instructions or sequence to the mobile device. The distribution or assignment system 140 distributes respective instructions or sequences to a plurality of mobile devices associated with the attendees. The distribution or assignment system 140 can provide the instructions or sequences to a mobile device by any of a large variety of ways. For example, in a pull type implementation, an application executing on a mobile device may use a link which identifies and allows downloading of a respective transducer activation sequence. In a push type implementation, the distribution or assignment system 140 may provide the respective transducer activation sequence to an application executing on the mobile device in response to some event or action, for instance purchasing of tickets for the event or detection of an arrival of the attendee with their mobile device at a venue.

In addition to transducer activation sequences, the distribution or assignment system 140 can also provide one or more synchronization and/or trigger signals 134 to one or more mobile devices. For example, the distribution or assignment system 140 may provide a signal 134 via a link. The signal 134 may be a cue to start the performance of the visual and/or aural show, or to start a specific visual and/or aural effect performance. The signal 134 may be a start time for a start of the performance of the visual and/or aural show, or start a specific visual and/or aural performance, thereby effectively acting as a trigger. The start time may be based on a “real world” time, as indicated by a clock executing on the mobile device or a clock signal received via a communications carrier or provider network. The signal 134 may be a cue to identify at the venue, such as a sound or visual cue or pattern of cues. Such may be particularly advantageous for temporally synchronizing the performance of the visual and/or aural show or specific visual and/or aural effect with various portions of the event being performed at the venue. As often happens, a performance may start late, for example due to an opening act running over an allotted time or a band being unprepared to start on time. Triggering the start of the visual and/or aural show to a dimming of house lights or playing of an opening chord or singing of an opening lyric or to an announcement allows simple and foolproof synchronization between the event and the show. Triggering the start of the visual and/or aural effect to, for example, an announcement (e.g., touchdown, goal, homerun) or playing of a specific song, allows simple and foolproof synchronization between specific acts that may occur during the event and the show of the visual and/or aural effect. Such may be particularly useful for acts that are unplanned or cannot be reliably scheduled, for instance scoring during a sporting event or a dynamically updated play list for a concert.

In some instances, mobile devices 160 may have provided a venue location indicating an expected location of the mobile device in the venue and received corresponding transducer activation sequences and possibly trigger or synchronization signal 134 before the attendee goes to the venue with their mobile device 160. At the event, the mobile device may receive or sense one or more trigger or synchronization signals 134. In response, the mobile devices 160 operate according to their respective transducer activation sequences. When displayed in the air, in conjunction with other mobile devices 160 in the ad hoc group or set, the cumulative effect is a visual and/or audio show, which may extend across all or a portion of the venue during the event. In this way, event attendees may participate in and enhance an event at a venue, as well as enhancing their own experience of the event. In one example, the attendee has a compatible application on their mobile device. The attendee may use the application to quickly register for an event. In response to registration, the application transmits and receives all required data or information to allow the attendee and their mobile device to participate as described above. Other, non-exclusive, possibilities include receiving data associated with the event or venue from a server. Such may, for example, include receiving photographs or images from a band playing at a concert, which may be in real- or almost real-time. Photographs or images may be received together with one or more transducer activation sequences.

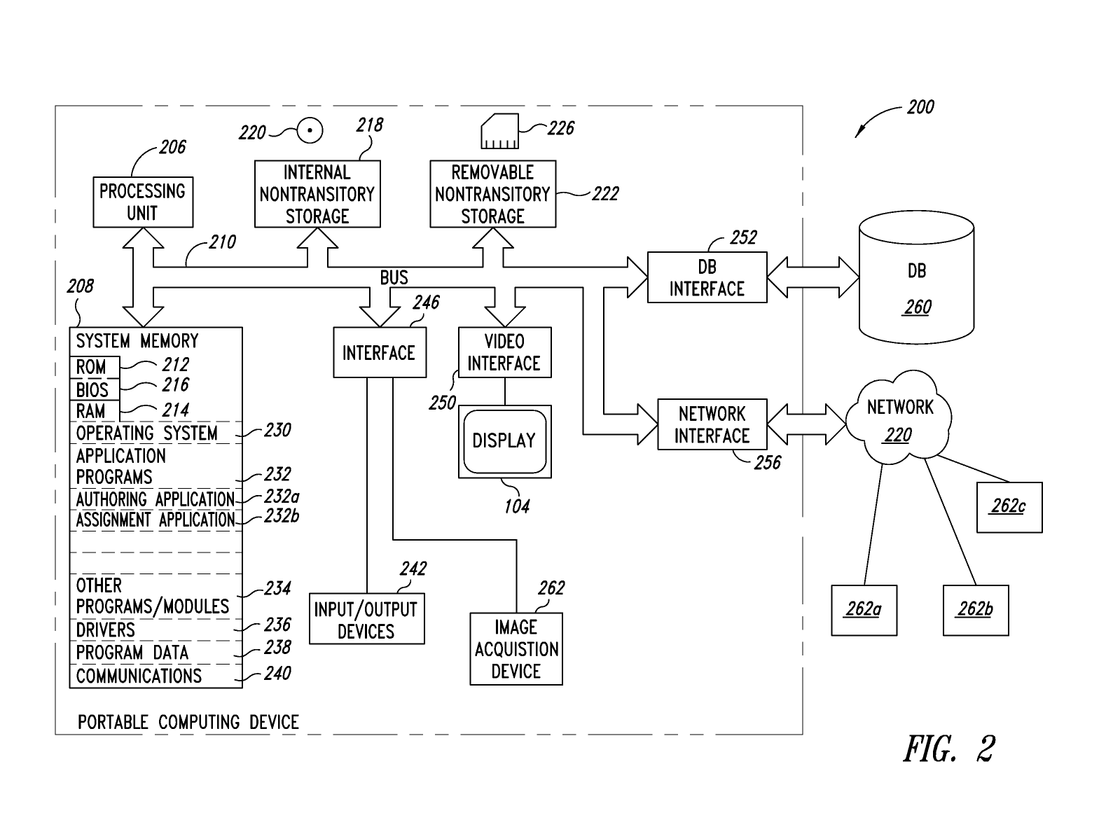

FIG. 2 is a block diagram of an example computing system 200 useful for implementing a show authoring and distribution system 100.

FIG. 2 and the following discussion provide a brief, general description of an exemplary computing system 200 that may be used to host authoring system 120 and the distribution or and assignment system 140. The authoring system 120 and the distribution or assignment system 140 may run on exemplary computing system 200 individually or together with other elements and features of authoring and distribution system 100. The computing system 200 may implement some or all of the various functions and operations discussed above in reference to FIG. 1.

Although not required, some portion of the embodiments will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including multiprocessor systems, microprocessor-based or programmable consumer electronics, personal computers (“PCs”), network PCs, minicomputers, mainframe computers, and other computing devices. The embodiments can be practiced in distributed computing environments where tasks or modules are performed by remote processing devices, which are linked through a communications network. In a distributed computing environment, program modules may be stored in both local and remote memory storage devices and executed using one or more local or remote processors, microprocessors, digital signal processors, controllers, or combinations thereof.

The computing system 200 may take the form of any current or future developed computing system capable of executing one or more instruction sets. The computing system 200 includes a processing unit 206, a system memory 208 and a system bus 210 that communicably couples various system components including the system memory 208 to the processing unit 206. The computing system 200 will at times be referred to in the singular herein, but this is not intended to limit the embodiments to a single system, since in certain embodiments, there will be more than one system or other networked computing device involved. Non-limiting examples of commercially available systems include, but are not limited to, an Atom, Pentium, or 80×86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 series processor as offered by Apple Inc., or a 68xxx series microprocessor as offered by Motorola Corporation.

The processing unit 206 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 2 are of conventional design. As a result, such blocks need not be described in further detail herein, as they will be understood by those skilled in the relevant art.

The system bus 210 can employ any known bus structures or architectures, including a memory bus with memory controller, a peripheral bus, and a local bus. The system memory 208 includes read-only memory (“ROM”) 212 and random access memory (“RAM”) 214. A basic input/output system (“BIOS”) 216, which can form part of the ROM 212, contains basic routines that help transfer information between elements within the computer system 200, such as during start-up. Some embodiments may employ separate buses for data, instructions and power.

Computer system 200 also includes one or more internal nontransitory storage systems 218. Such internal nontransitory storage systems 218 may include, but are not limited to, any current or future developed persistent storage device 220. Such persistent storage devices 220 may include, without limitation, magnetic storage devices such as hard disc drives, electromagnetic storage devices such as memristors, molecular storage devices, quantum storage devices, electrostatic storage devices such as solid state drives, and the like.

Computer system 200 may also include one or more optional removable nontransitory storage systems 222. Such removable nontransitory storage systems 222 may include, but are not limited to, any current or future developed removable persistent storage device 226. Such removable persistent storage devices 226 may include, without limitation, magnetic storage devices, electromagnetic storage devices such as memristors, molecular storage devices, quantum storage devices, and electrostatic storage devices such as secure digital (“SD”) drives, USB drives, memory sticks, or the like.

The one or more internal nontransitory storage systems 218 and the one or more optional removable nontransitory storage systems 222 communicate with the processing unit 206 via the system bus 210. The one or more internal nontransitory storage systems 218 and the one or more optional removable nontransitory storage systems 222 may include interfaces or device controllers (not shown) communicably coupled between nontransitory storage system and the system bus 210, as is known by those skilled in the relevant art. The nontransitory storage systems 218, 222, and their associated storage devices 220, 226 provide nonvolatile storage of computer-readable instructions, data structures, program modules and other data for the computing system 200. Those skilled in the relevant art will appreciate that other types of storage devices may be employed to store digital data accessible by a computer, such as magnetic cassettes, flash memory cards, Bernoulli cartridges, RAMs, ROMs, smart cards, etc.

Program modules can be stored in the system memory 208, such as an operating system 230, one or more application programs 232, other programs or modules 234, drivers 236 and program data 238.

The application programs 232 may, for example, include one or more programs which are a part of a show authoring and distribution system 100 such as an authoring application (232a) and assignment application (232b). The application programs 332 may also include one or more programs for data storage such as database programs for storing venue plans and generated data such as transducer activation sequences.

The system memory 208 may also include other programs/modules 234, such as including logic for calibrating and/or otherwise training various aspects of computing system 200. The other programs/modules 234 may additionally include various other logic for performing various other operations and/or tasks.

The system memory 208 may also include any number of communications programs 240 to permit computing system 200 to access and exchange data with other systems or components, such as with the mobile devices 262a to 262c and/or optionally with one or more other computer systems and devices such as one or more back end or distribution systems.

While shown in FIG. 2 as being stored in the system memory 208, all or a portion of the operating system 330, application programs 232, other programs/modules 234, drivers 236, program data 238 and communications 240 can be stored on the persistent storage device 220 of the one or more internal nontransitory storage systems 218 or the removable persistent storage device 226 of the one or more optional removable nontransitory storage systems 222.

A user can enter commands and information into the computing system 200 using one or more input/output (I/O) devices 242. Such I/O devices 242 may include any current or future developed input device capable of transforming a user action or a received input signal to a digital input. Example input devices include, but are not limited to, a touchscreen, a physical or virtual keyboard, a microphone, a pointing device, a foot control or switch, or the like. These and other input devices are connected to the processing unit 206 through an interface 246 such as a universal serial bus (“USB”) interface communicably coupled to the system bus 210, although other interfaces such as a parallel port, a game port or a wireless interface or a serial port may be used. A display 204 or similar output device is communicably coupled to the system bus 210 via a video interface 250, such as a video adapter or graphical processing unit (“GPU”).

One or more output devices 242 may be communicably coupled to the interface 246. Such output devices may include one or more wireless radio frequency transceivers. Computing system 200 is coupled to a set of mobile devices 262a-262c via network 220, to which computing system 200 is communicatively coupled via network interface 256 which in turn is coupled to bus 210.

Mobile devices 262a-262c may be coupled through network 220 to network interface 256 to provide data to processing unit 206, and such data may include registration data involving a venue location association specific to the mobile device. Mobile devices 262a-262c may receive sets of instructions from computing system 200 over network 220 providing one or more respective transducer activation sequences and these transducer activation sequences may be associated with the venue location in which the mobile device will be located during an event at a venue.

Furthermore, although not illustrated here, the computing system 200 may provide a signal to mobile devices 262a-262c. Further, execution of the sets of instructions received by mobile devices 262a-262c may be caused by detection of this signal at one or more of mobile devices 262a-262c, and/or one or more of mobile devices 262a-262c may be remotely triggered via the network 220.

In some embodiments, computing system 200 operates in an environment using one or more of the communications interfaces to optionally communicably couple to one or more remote computers, servers and/or other devices via one or more communications channels, for example, one or more networks such as the network 220. These logical connections may facilitate any known method of permitting computers to communicate, such as through one or more LANs and/or WANs. Such networking environments are well known in wired and wireless enterprise-wide computer networks, intranets, extranets, and the Internet.

In some embodiments, the network interface 256, which is communicably coupled to the system bus 210, may be used for establishing communications over the network 220. Further, the database interface 252, which is communicably coupled to the system bus 210, may be used for establishing communications with a database stored on one or more computer-readable media 260. For example, such a database 260 may include a repository for storing data associated with a venue or event.

Those skilled in the relevant art will recognize that the network connections shown in FIG. 2 are only some examples of ways of establishing communications between devices, and other connections may be used, including wirelessly. In some embodiments, program modules, application programs, or data, or portions thereof, can even be stored in other computer systems or other devices (not shown).

For convenience, the processing unit 206, system memory 208, network port 256 and interfaces 246, 252 are illustrated as communicably coupled to each other via the system bus 210, thereby providing connectivity between the above-described components. In alternative embodiments of the computing system 200, the above-described components may be communicably coupled in a different manner than illustrated in FIG. 2. For example, one or more of the above-described components may be directly coupled to other components, or may be coupled to each other, via intermediary components (not shown). In some embodiments, system bus 210 is omitted and the components are coupled directly to each other using suitable connections.

FIG. 4 shows a user interface 400 for interfacing with the authoring system 120 of FIG. 1, according to one illustrated embodiment.

The user interface 400 could, for example, be displayed on a display such as display 204 of FIG. 2. User interface 400 provides a venue display window 410 displaying a layout of a selected venue for an event. The venue layout may be selected from a list of a library of venues 414 provided in the user interface 400. Alternatively, the venue layout may, for example, be obtained via venue plug-in 416. Venue plug-in 416 may be a library plug-in which provides venue mappings for events and is obtained by a user as needed.

The user interface 400 may further include selection entry field 420 for a selection of a location in the venue. The end user selects or identifies a venue location (i.e., location in a venue) at which a visual and/or aural effect or portion thereof will be produced via one or more attendee mobile devices which are at least expected to be at the specified location. The end user may, for example, select or identify a seat in the venue or set of seats in the venue. The end user may also specify a timing of the visual and/or aural effect or portion thereof. A selection sequence field 424 of the user interface 400 may show selected sequences for the locations or mobile devices, and other data related thereto, for viewing by an end user who is authoring the show.

Venue locations may be identified in a variety of ways. For example, venue locations may be identified by specific seat identifiers (e.g., floor or level, section, aisle, row, seat numbers, letters or other identifiers). For example, venue locations may be identified by relative offset from a defined point or location, either in two-dimensional area or three-dimensional space.

By selecting venue locations within the selected venue in venue display 410, an visual and/or aural show may be designed via the user interface 400. More particularly, an author of a show may select venue locations via the venue display 410 for different visual and/or aural effects, including specifying an order and/or specific times or cues for starting the show or specific visual and/or aural effects. Through this selection or identification of venue locations and/or times or cues, patterns and shows can be designed for presentation at a venue during a scheduled event. Again, the various sequences for implementing the desired shows, patterns, and/or effects are presented in selection sequence field 424 for end user review. These sequences relative to venue locations are typically temporal sequences for driving one or more transducers of respective mobile devices to produce visual and/or audio output.

The user interface 400 of FIG. 4 further provides a registered participants field 432, which provides an indication of the number of attendees who have registered as participants. The registered participants field 432 may also display a layout of seats which are associated with the registered participants, or can otherwise provide information regarding attendees who have either registered or are actually participating to the end user. The user interface 400 further provides for grouping seats via a pixel augmentation tool 434. Pixel augmentation tool 434 allows for individual seats, attendees and/or mobile devices to be grouped. More specifically, the pixel augmentation tool 434 allows seating in a venue to be grouped and addressed as a single logical unit or pixel for associating with respective transducer activation sequences. Thus, grouped mobile devices will receive and execute the same transducer activation sequence, effectively operating as a pixel in a presentation of a show or visual and/or aural effect. While in most instances contiguous seats will be grouped together, certain visual or aural effects may require grouping of non-contiguous seats, and some groups may even spatially overlap with other groups.

A select synchronization signal field 436 allows an end user to select one or more signals or cues for triggering or synchronizing mobile devices with regard to the generated transducer activation sequences. The signals or cues for triggering or synchronizing the mobile devices may, for example, be provided to the mobile devices as sets of instructions or as an event chronology at the venue.

As shown in FIG. 4, the user interface 400 provides for generation of transducer activation sequences and distribution or assignment of the generation of transducer activation sequences to various mobile devices.

A generate mobile device instructions icon 442 allows an end user to cause the authoring system 120 to generate transducer activation sequences in the form of sets of instructions executable by processors on the mobile devices. Selection may cause an automatic mapping of a design (e.g., graphic, message, sequence of visuals or sounds) or a visual or aural effect to seats or groups of seats, for example based in part on location selections made by the end user. The transducer activation sequences may specify temporal information for activating one or more transducers of a mobile device, the sequences specified for each pixel of the design or visual or aural effect.

A transmit mobile device instructions icon 444 allows an end user to cause the generated transducer activation sequences to be transmitted (e.g., pushed) to mobile devices for execution during the event at the venue, as discussed above. In some implementations, selection of the transmit mobile device instructions icon 444 causes the distribution or assignment system 140 to make the transducer activation sequences available to mobile devices. In other implementations, selection of the transmit mobile device instructions icon 444 causes the distribution or assignment system 140 to actively push the transducer activation sequences to known or registered mobile devices. Alternatively, selection of the transmit mobile device instructions icon 444 causes the distribution or assignment system 140 to push or otherwise provide links or notifications of the availability of transducer activation sequences for download.

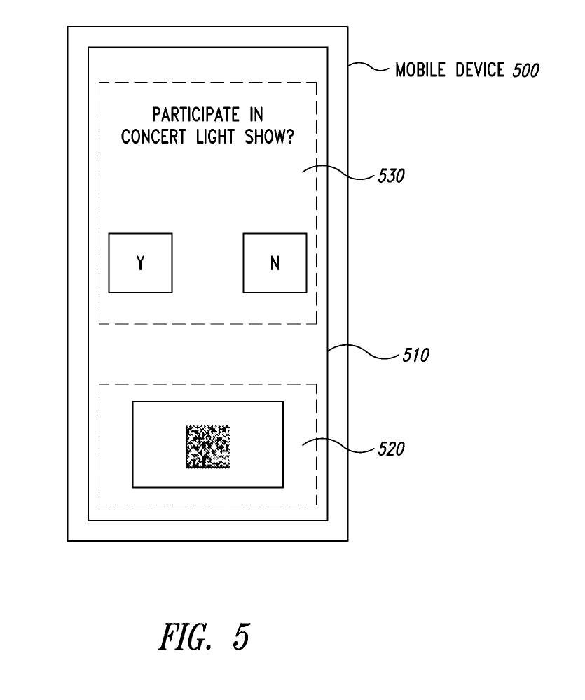

FIG. 5 shows a mobile device 500, according to one illustrated embodiment.

The mobile device 500 includes or presents a user interface 510. The user interface 500 presents a machine-readable symbol (e.g., barcode symbol, area or matrix code symbol, QR symbol) 520 which can be read or scanned at a venue to gain entrance to an event. The user interface 500 may also present a participation prompt 530, prompting the attendee to participate in a visual or aural show that will be presented or performed at the event.

An application executing on mobile device 500 may present or provide the user interface 500. In response to the attendee selecting a prompt (Y) indicating acceptance of the invitation to participate, the machine-readable symbol 520 can be changed or modified to indicate that the attendee has registered to participate. In response to a reading the changed or modified machine-readable symbol 520, for example to gain entrance to the venue, the reader may prompt the distribution or assignment system 140 to push a respective generated transducer activation sequence to the mobile device 500 of the attendee for participation in the show. More specifically, changed or modified machine-readable symbol 520 may specify location information (e.g., seating), and in response to obtaining the location information, the transducer activation sequences associated with the respective seat is pushed or otherwise provided to the respective mobile device.

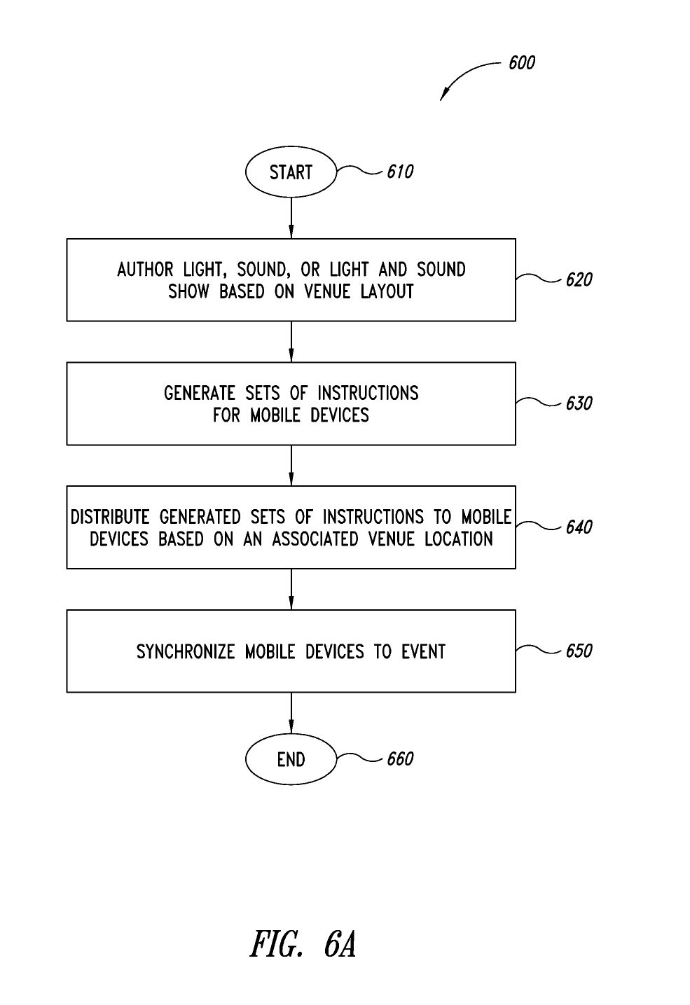

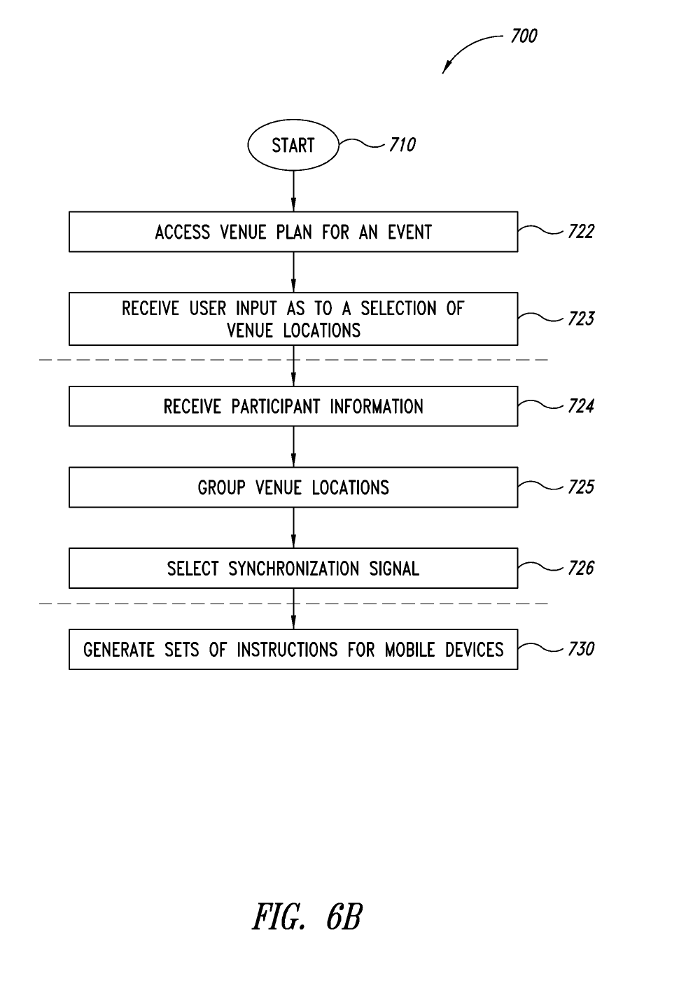

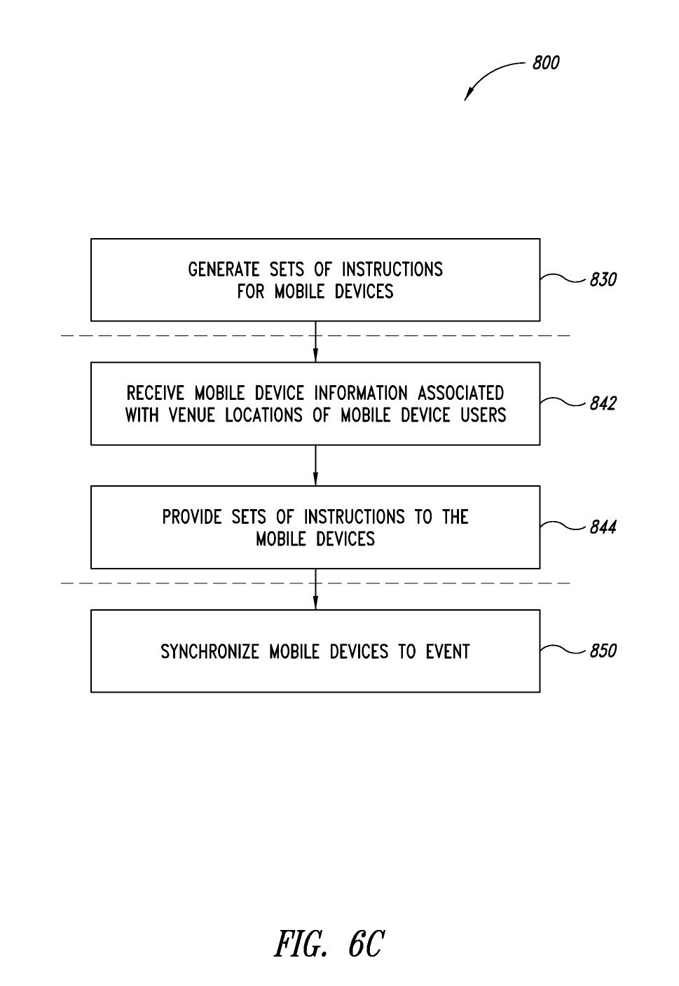

FIG. 6A shows a high level a method 600 of operation in a show authoring and distribution or assignment system 100 (FIG. 1), according to one illustrated embodiment.

The method 600 may be implemented using the user interface 400 (FIG. 4) presented via a display such as display 204 (FIG. 2).

The method 600 starts at 610, for example in response to a power up or turning ON of the authoring system 120.

At 620, a light, sound, or sound and light show is authored based on a venue layout for an event. More particularly, based at least one layout of the venue for a particular event, a show or individual visual and/or aural effects are designed for presentation via ad hoc groups or sets of mobile devices in the possession of event attendees. The author uses the authoring system 120 to specify designs of one or more visual and/or audio effects, which are presented by mobile devices at a plurality of locations within a venue. The authoring system 120 may automatically break apart a design, which may be both spatial and temporal, into pixels. The authoring system 120 may map the pixels of the design to specific locations (e.g., seats, groups of seats, areas such as the floor or mezzanine), and generate sets of instructions on a location by location basis. Again, the authoring system 120 may map the pixels of the design in a 1:1 ratio to the seats, or may be map in other ratios for instance 1:4, 1:8, 1:16, 1:32, etc. The ratios may be based on end user input, registration by attendees as participants, and/or actual participation as sensed and indicated by a mobile. When combined across a span of an ad hoc group of devices located at different locations in the venue, this allows a show to be designed across the audience at a venue.

At 630, sets of instructions are generated for mobile devices, for example based on the input received at 620. These sets of instructions when executed by a mobile device are effectively transducer activation sequences which cause output from the mobile devices at defined times relative to a start time or in response to one or more cues. These sets of instructions are generated based on relative locations within the venue such that different locations within a venue may have different sets of instructions specifying different transducer activation sequences.

At 640, the distribution or assignment system 140 distributes these generated sets of instructions to mobile devices based on an associated venue location at which the mobile device is located or expected to be located. For example, an author may have designed a show specifying that the screen of a mobile device should flash for a desired time at a desired venue location, such as a seat at an event. The resulting generated set of instructions would be provided to the mobile device (e.g., smartphone) of an attendee who will sit in the seat, causing the mobile device phone to be actuated as desired during the event to enhance the event with a further show. Thus, by generating different transducer activation sequences for different locations in a venue, shows are effectuated using participating attendees in the audience via activation of the mobiles devices of the participating attendees.

At 650, the mobile devices are synchronized. This ensures that mobile devices actuate in synchronization, for example in time relative to each other and/or in synchronization with the event. For example, the mobile devices may be synchronized to the event and/or to each other. Synchronization at 650 can be affected differently for different mobile devices. For example, some mobile devices may receive a synchronization signal over a network, while other mobile devices may receive an indication of a synchronization signal that may be provided in real time at the event and detected by the mobile device.

Method 600 ends at 660, which may be before, during or after the relevant event.

FIG. 6B shows a low level method 700 of operation in a show authoring and distribution or assignment system 100 (FIG. 1), according to one illustrated embodiment. The method 700 may be employed in performing the method 600 (FIG. 6A), particularly the authoring at 620 (FIG. 6A).

The method 700 starts at 710, for example in response to call from another routine.

At 722, an author accesses and views venue plans for an event (such as illustrated in FIGS. 3A and 3B) via the show authoring system. At 723, the show authoring system receives user input indicative of a selection of specified or desired locations in the venue and optionally associated times. Optionally at 724, the authoring system 120 or the distribution or assignment 140 receives participant information. The authoring system 120 or the distribution or assignment 140 may use the participant information in generating or distributing the transducer activation sequences.

Optionally at 725, the authoring system 120 groups two or more venue locations together. Thus, groups of attendees, for instance attendees in a general vicinity of each other, can be grouped together as effective pixels. This may provide a logical reduction of attendees to a block in the venue.

At 726, an author may select a synchronization signal or cue for the show or for one or more visual and/aural effects to trigger one or more mobile devices. While synchronization has been discussed with regard to 650 above, the synchronization signal can be selected at any time. Additionally, multiple signals can be selected for synchronization or triggering. The signals can be provided to mobile devices at multiple different times or concurrently. At 730, which may correspond to 630 in method 600 of FIG. 6A, the authoring system 120 generates sets of instructions for mobile devices.

FIG. 6C shows a low level method 800 of operation in a show authoring and distribution or assignment system 100 (FIG. 1), according to one illustrated embodiment. The method 800 may be employed in performing the method 600 (FIG. 6A), particularly the distribution or assignment at 640 (FIG. 6A).

At 830 of method 800, which may correspond to 630 in method 600 of FIG. 6A, sets of instructions for mobile devices have been generated.

At 842, the authoring system 120 and/or distribution or assignment system 140 receives mobile device information associated with expected or actual venue locations of mobile device users. For example, an attendee may have purchased a ticket for a specific seat at an event with an application executing on the attendee's mobile device. The application provides mobile device information together with the seat location (an example of relative venue location) to, for example, a server. This may be performed as part of a ticket purchase, or in response to a ticket purchase, for instance after a seat selection is confirmed.

At 844, based on the anticipated relative location of a mobile device in the venue, one or more instruction sets are provided to the mobile device. Building upon the above example, when a server knows a seat associated with a mobile device, and identification of the mobile device, the server may retrieve a set of instructions associated with the selected seat and provide the set of instructions to the mobile device via the identification of the mobile device. Alternatively, the server could also provide the mobile device with a link to storage medium (e.g., database associated with a Website) that stores the relevant set(s) of instructions for the relative venue location.

At 850, which may correspond to 650 in method 600 of FIG. 6A, mobile devices are synchronized to the event.

Aspects can also involve mobile devices used as selection mechanisms. For example, a set of mobile devices can be actuated such that the number of mobile devices in the set which are actuated decreases over time, to arrive a subset of the original set of mobile devices. This can be used to select mobile device users. For example, a contest winner can be selected by randomly lighting up mobile devices throughout a venue and then settling on lighting up one device to indicate a winner by dropping mobile devices out of actuation. Of course this is just an example, and a set of mobile devices could be selected for actuation which grows over time to indicate a set of winners, namely the users of the actuated/actuating mobile devices.

In practical implementation, it is necessary to design the show and mobile device output for less than total participation. To this end, multiple adjacent venue locations, such as individual seats, may be amalgamated into pixels. Thus, each pixel will include one or more venue locations such as seats and so will span potentially many attendees. The related pixel size can be selected to accommodate an estimated participation percentage or an actual participation percentage. That is, the number of attendees in a logical pixel may be selected based upon how much participation is likely. When designing a show, it would be desirable that every pixel had at least one participant to avoid holes or black spots in the pattern(s) of the show. Since it is possible to know seat numbers and relative venue location within a venue, the location of holes in a show is known and it might be possible to dynamically adjust in some circumstances through adjusting pixel size. This could include dynamic control of mobile devices at the event or by making available new transducer activation sequences to mobile devices. Similarly, it might be possible to level the intensity balance using pixels for the actual participation.

Because many attendees take photos during modern events, and because aspects disclosed herein provide for correlating mobile devices with relative venue locations, it is possible that applications executing on mobile devices and a server could operate together to stitch together the photos taken by multiple attendees to create an oriented linkage of photographs and these photographs may further be sorted by relative time of acquisition to provide a oriented photographic panorama of the event over a relative period of time.

In still further enhanced developments, it may be possible to derive valuable data. For example, from collected data, for example from data forwarded on by the mobile device app and compiled at a server, it may be possible to determine if seat costs affects participation, or if there a relation between seat cost and class or type of mobile device. Such information can be derived based on relative venue location such as venue seating location.

### Example Scenarios

You download the mobile app, go to a concert, enter your seat number and become part of the show. During the show the band tells you to hold up your phone and you become a pixel in an amazing, colorful, time sequenced light show that travels throughout the stadium. The light show was designed by the band to go along with specific songs during the concert.

A controlling system creates amazing light shows using the user's phone as a smart colored pixel based on the seat location. Imagine sitting in your seat and looking across to the other side of the stadium and seeing thousands of phones held up showing sequences of colorful lights or maybe even a stadium high picture of a flying pig circling the stadium by using multiple fans' phones as pixels in a giant display.

Bands use the app/system to entertain and engage fans during the show, interact with them pre- and post-show, giving them the ability to share with their fans and their fans' friends via social networks. Pre- and post-concert, bands can engage fans by posting music, notes, pictures, polls, and other info. In addition, photos that fans take at the concert can be stored and shared with all other fans through the mobile app.

Eventually, the system becomes the new social network for all forward thinking bands and their fans. The key to user adoption is that fans download the app to be part of the show and continue using the app to get content from their favorite bands.

For example, a band wants its fans to participate in its concert and continue to participate with each other after the show. They want to create a light show during certain songs where each fan is a pixel in the show and the pixels can change colors and sequence throughout the stadium. They purchase the relevant system and pay a license fee for events. Using the authoring system, they bring up the stadium where they'll be playing and create a time based sequence of colors and pixels based on seat locations. They have complete control over what seat's phone is what color at what time and for how long so the sophistication of the light show is based on their imagination and the time they spend to create it. The band hires consultants to create the light show for them based on their input. The authoring system simulates the show on the computer screen so the band can approve the final result before the concert.

In addition to creating a sequence of pixels throughout the venue, the band wants to include sound that moves throughout the stadium and also wants the pixels within the crowd to create large pictures taking up half the stadium that the people on the other side of the stadium will be able to see.

Building upon the above example, a fan just bought tickets to see the band in concert. He reads that all fans with a smartphone should make sure they download an “app” so they can participate in the show. The fan goes to an on-line store and downloads and runs the relevant app. The app starts and queries the fan what concert(s) he's planning to attend and shows some upcoming concerts in his area (based on location of the phone). The fan sees the band and clicks on it and picks the date he's going to attend. The app asks the fan for his seat number and informs him that it needs the seat number so the fan can be part of the show. The app also asks the fan if he'd like to register in order to receive free video and audio from the band—the fan can register using his Facebook account or by providing his own username/password to create an account. There's also a place where the fan can enter his twitter username. The fan now is presented with the option to share with his friends via Facebook or Twitter that he's using the app and going to the concert.

At the concert, a push message buzzes the fan's phone letting him know it's almost time to take the phone out of his pocket to be part of the show. The band asks everyone to pull out their phones and the fan turns on his phone and holds it up. As the band plays, an amazing light show occurs using each person's phone as a pixel. The fan looks around the stadium and watches an incredible sequence of lights throughout the stadium.

The fan purchases his next concert ticket for the band from the app. The app queries the fan if he'd like a parking permit for the concert for $20 and the fan says yes.

When the day arrives for the next concert, the fan's phone buzzes with a message letting him know that the concert is today and asks him if he'd like to join up with other concert goers in an online pre-party. The pre-party is like a message area on the phone and band members contribute thoughts on tonight's concert as well as polling fans for what they want to hear. When the fan arrives to the concert, he goes to the parking lot he purchased a ticket for and shows them the QR code for the parking pass on his phone and the attendant scans it and lets him in. To get inside the venue, he brings up his app and the doorman scans the QR code on his phone. During the concert, the fan takes pictures and is asked by the app if he wants to share them with other concert goers and he says yes. He has an option to post them to his Facebook account, too. During the concert a message buzzes the fan's phone letting him know it's almost time to take the phone out of his pocket to be part of the show. The band asks everyone to pull out their phones and the fan turns on his phone and holds it up. As the band plays, an amazing light show occurs using each person's phone as a pixel. The app randomly picks 20 people with the app and gives them a backstage pass. After the show, they show their winning pass on their phone and are allowed backstage to meet the band. Pictures that fans are taking during the show are displayed on the big screens throughout the venue.

The next day, the fan loads up the app on his mobile device and looks at all of the pictures others took during the show. The band members also post some of their pictures of the concert and pre- and post-concert photos. The fan sees a concert shirt he'd like to purchase and clicks on it to order. The band publishes a song that was recorded live at the concert for the app users to listen to and the fan listens to it and saves it to his music player playlist.

Although specific embodiments and examples are described herein for illustrative purposes, various equivalent modifications can be made without departing from the spirit and scope of the invention, as will be recognized by those skilled in the relevant art. The teachings provided herein can be applied broadly across venues or events. For example, the teachings can employ wireless communications devices such as cellular telephones, and cellular systems. Additionally, the teachings can employ networks other than dedicated Extranets, for example, the teachings may employ a network such as the Worldwide Web portion on the Internet, to interconnect some or all of the various described components. The various embodiments described above can be combined to provide further embodiments. All of the commonly assigned US patent application publications, US patent applications, foreign patents, foreign patent applications and non-patent publications referred to in this specification and/or listed in the Application Data Sheet, including but not limited to U.S. Provisional Application Ser. No. 61/843,269, filed Jul. 5, 2013 are incorporated herein by reference, in their entirety. The illustrated methods can omit some acts, can add other acts, and can execute the acts in a different order than that illustrated to achieve the advantages of the invention.

While generally explained in terms of a concert, such techniques and embodiments described herein are suitable for venues or events generally and as such the described embodiments are not limited to concert settings, but may be used broadly with regard to events or venues. For example, so long as a venue is populated with end-users together with their mobile devices, aspects as provided herewith may be used to supplement an event at a venue.

These and other changes can be made to the invention in light of the above detailed description. In general, in the following claims, the terms used should not be construed to limit the invention to specific embodiments disclosed in the specification, but should be construed to include all computers, networks, databases, and wireless communications devices that operate in accordance with the claims. Accordingly, the invention is not limited by the disclosure, but instead its scope is to be determined entirely by the following claims.

What is claimed is:

1. An assignment system to configure light, sound, or light and sound shows by ad hoc groups of mobile devices, the assignment system comprising:
at least one non-transitory processor readable medium that stores relationships between seating layouts for each of a number of venues and sets of instructions executable by mobile devices possessed by a plurality of attendees of at least one event at the selected one of the venues, the seating layouts specifying each respective venue a respective position of each of a plurality of seats in the respective venue for at least one event scheduled for the respective venue, and the set of instructions specifying a temporal sequence of instructions to actuate at least one transducer of the respective mobile devices to emit at least one of light, sound, or light and sound which in totality form at least part of the light show, the sound show or the light and sound show; and
at least one circuit communicatively coupled to the at least one non-transitory processor readable medium, and which provides at least one of a set of instructions or a link to a set of instructions to each of a plurality of mobile devices based at least in part on a seat logically associated with the respective mobile device for an identified venue and an identified event scheduled at the identified venue.

2. The assignment system of claim 1 wherein the at least one circuit comprises at least one processor unit, and is communicatively coupled to a communications network to receive requests from the attendees and to provide the set of instructions to at least one of a computer system or a respective mobile device in response to received requests.

3. The assignment system of claim 1 wherein the at least one circuit comprises at least one processor unit, and is communicatively coupled to provide the set of instructions to at least one of a computer system or a respective mobile device in response to or as a part of a ticket purchase.

4. The assignment system of claim 1 wherein the at least one circuit comprises at least one processor unit, and is communicatively coupled to provide the set of instructions to at least one of a computer system or a respective mobile device in response to a registration with a service by at least one of a respective one of the attendees or a respective one of the mobile devices.

5. The assignment system of claim 1 wherein the at least one circuit comprises at least one processor unit, and is communicatively coupled to receive seat specification information entered by an attendee and indicative of a seat in a venue at an event and to provide the set of instructions to at least one of a computer system or a respective mobile device in response to the received seat specification information.

6. The assignment system of claim 1 wherein the at least one circuit comprises at least one processor unit, and is communicatively coupled to receive seat specification information as part of a ticket acquisition process which is indicative of a seat in a venue at an event and to provide the set of instructions to at least one of a computer system or a respective mobile device in response to the received seat specification information.

7. The assignment system of claim 2 wherein the at least one circuit comprises at least one processor unit, and is communicatively coupled to receive location specification information which includes geolocation coordinates derived by a geolocation system.

8. An assignment method to configure light, sound, or light and sound shows by ad hoc groups of mobile devices, the assignment method comprising:
storing relationships between seating layouts for each of a number of venues and sets of instructions executable by mobile devices possessed by a plurality of attendees of at least one event at the selected one of the venues, the seating layouts specifying each respective venue a respective position of each of a plurality of seats in the respective venue for at least one event scheduled for the respective venue, and the set of instructions specifying a temporal sequence of instructions to actuate at least one transducer of the respective mobile devices to emit at least one of light, sound, or light and sound which in totality form at least part of the light show, the sound show or the light and sound show; and
providing at least one of a set of instructions or a link to a set of instructions to each of a plurality of mobile devices based at least in part on a seat logically associated with the respective mobile device for an identified venue and an identified event scheduled at the identified venue.

9. The assignment method of claim 8, further comprising receiving requests from the attendees over a communications network and wherein providing the set of instructions or a link to a set of instructions includes providing the set of instructions or the link to a set of instructions to respective ones of the mobile devices in response to received requests.

10. The assignment method of claim 8, further comprising receiving requests from the attendees over a communications network and wherein providing the set of instructions or a link to a set of instructions includes providing the set of instructions or the link to a set of instructions to respective mobile devices over a communications network in response to or as a part of a ticket purchase.

11. The assignment method of claim 8, further comprising receiving requests from the attendees over a communications network and wherein providing the set of instructions or a link to a set of instructions includes providing the set of instructions or the link to a set of instructions to respective mobile devices in response to a registration with a service by at least one of a respective one of the attendees or a respective one of the mobile devices.

12. The assignment method of claim 8, further comprising receiving seat specification information entered by an attendee and indicative of a seat in a venue at an event and wherein providing the set of instructions or a link to a set of instructions includes providing the set of instructions or the link to a set of instructions to a respective mobile device in response to the received seat specification information.

13. The assignment method of claim 8, further comprising receiving seat specification information as part of a ticket acquisition process which is indicative of a seat in a venue at an event and wherein providing the set of instructions or a link to a set of instructions includes providing the set of instructions or the link to a set of instructions to a respective mobile device in response to the received seat specification information.

14. The assignment method of claim 8, further comprising receiving location specification information including geolocation coordinates derived by a geolocation system.

15. A system to control ad hoc groups of mobile devices, the system comprising:
at least one non-transitory processor readable medium that stores at least one of processor-executable instructions or data; and
at least one circuit communicatively coupled to the at least one non-transitory processor readable medium, and which provides a plurality of sets of instructions executable by each of a plurality of mobile devices possessed by respective ones of a plurality of attendees of at least one event at a venue, the sets of instructions which cause at least one transducer of the respective mobile devices to alternate between emitting and not emitting light in an at least simulated random pattern, and which cause the transducer of all except a defined number of the respective mobile devices to stop alternating and no longer emit light after a period, to indicate at least one winner of a game.

16. The system of claim 15 wherein the at least one circuit provides the sets of instructions only to mobile devices that have registered to participate in the game.

17. The system of claim 15 wherein the at least one circuit provides the sets of instructions which linearly reduces a total number of the mobile devices alternating between emitting and not emitting light over time.

18. The system of claim 15 wherein the at least one non-transitory processor readable medium that stores a seating layout for at least the venue, the seating layouts specifying a respective position of each of a plurality of seats in the venue for at least one event scheduled for the venue; and the at least one circuit provides the sets of instructions only to mobile devices based on a position of a respective seat logically associated with the mobile device.

19. The system of claim 15 wherein the at least one non-transitory processor readable medium that stores a seating layout for at least the venue, the seating layouts specifying a respective position of each of a plurality of seats in the venue for at least one event scheduled for the venue; and the at least one circuit verifies a winner of the game based at least in part on a position of a respective seat logically associated with the mobile device.

20. The system of claim 15 wherein the at least one circuit incorporates a trigger event definition in the form of at least one of a sound or a visual cue in the sets of instructions, the at least one of the sound or the visual cue substantially concurrently detectable by the mobile devices at the event.
